(19) United States
(12) Patent Application Publication
(10) Pub. No.: US 2008/0076436 A1
(43) Pub. Date: Mar. 27, 2008

(54) Call setup in a wireless communication system

(76) Inventors: Charles Albert Sanders, Bridgewater, NJ (US); Susan Wu Sanders, Bridgewater, NJ (US)

Correspondence Address: Lucent Technologies Inc.;Docket Administrator, Room 3J-219, 101 Crawfords Corner Road, Holmdel, NJ, 07733-3030, US

(21) Appl. No.: 11/527,847

(22) Filed: Sep. 27, 2006

(51) Int. Cl. H04Q 7/20

(52) U.S. Cl. 455/450

(57) ABSTRACT

A method of call setup in a wireless communication system in which cross carrier Y traffic channels at a serving base station and one or more neighbor base stations are assigned to a mobile station during system access to improve call setup when the mobile station is in a cross carrier Y cell or coverage area of one of the neighbor base stations. The serving base station is selected by the mobile station based on the signal quality of an access carrier X. Traffic channels are assigned to the mobile station on the cross carrier Y at the serving base station and one or more neighbor base stations. If the cross carrier Y cell of the serving base station covers less geographical area than a corresponding access carrier X cell, then the mobile station may be in the cross carrier Y cell of one of the neighbor base stations. In such a case, the mobile station should be able to establish a communication link with that neighbor base station even though it may not be able to establish a communication link with the serving base station, thereby improving call setup in cross carrier channel assignments.

### FIELD OF THE INVENTION

The present invention relates generally to wireless communication systems and, in particular, to call setup in wireless communication systems.

### BACKGROUND OF THE RELATED ART

Call setup is a procedure for establishing communication links, such as traffic channels, between mobile stations and base stations in wireless communication systems. Call setup occurs during system access when a mobile station is attempting to access the wireless communication system and establish a communication link with a base station.

Call setup is initiated by the mobile station. The mobile station monitors pilot channels of one or more base stations in the wireless communication system by measuring the signal quality, e.g., signal strength, of the pilot channels. Based on the signal quality measurements, the mobile station selects a base station to be its serving base station. Typically, the base station associated with the best signal quality, e.g., strongest signal strength, is selected as the serving base station. Such selection technique is based on the assumption that the pilot channel signal quality is a reliable indicator of traffic channel signal quality. The mobile station will then attempt to establish a communication link with the serving base station by transmitting an access request to the serving base station over an access channel. The access request is a request for traffic channel assignment at the serving base station. The serving base station responds by assigning a traffic channel, i.e., allocates resources for setting up a traffic channel, to the mobile station and subsequently transmitting a channel assignment message over a paging or other control channel indicating the assigned traffic channel. Call setup is completed when the mobile station establishes a communication link with the serving base station using the assigned traffic channel.

Call setup can fail for a number of reasons. One reason for failure is due to signal quality differences on the pilot channel and assigned traffic channel (hereinafter referred to herein as a “pilot and traffic signal quality differences”). Call failures due to these differences occur more frequently in multi-carrier wireless communication systems than in single carrier communication systems.

In a single carrier wireless communication system, a pair of carrier frequencies, i.e., an uplink carrier frequency and a downlink carrier frequency, is used for communication between the mobile station and base station. A set of communication channels, including the pilot and traffic channels, share the downlink carrier frequency and, thus, pilot channel signal quality should be a reliable indicator of assigned traffic channel signal quality. Call setup failures associated with pilot and traffic signal quality differences, in single carrier wireless communication systems, may occur as a result of rapidly fluctuating fading conditions between the mobile station and serving base station.

In a multi-carrier wireless communication system, two or more pairs of carrier frequencies are used for communication between the mobile station and base station. A different set of communication channels is used for each of the downlink carrier frequencies. Each set of communication channels include a pilot channel and a plurality of traffic channels. The mobile station is configured to monitor the pilot channel on only one of the carrier frequencies when attempting to access the wireless communication system. Such carrier frequency is referred to herein as an “access carrier.” The assigned traffic channel may be on the access carrier or one of the other carriers (also referred to herein as “cross carriers”). An assignment of a traffic channel on the access carrier is referred to herein as a “same carrier channel assignment.” An assignment of a traffic channel on the cross carrier is referred to herein as a “cross carrier channel assignment.”

In same carrier channel assignments, the pilot channel signal quality is usually a reliable indicator of the assigned traffic channel signal quality. In cross carrier channel assignments, the pilot channel signal quality may not be a reliable indicator of the assigned traffic channel signal quality due to differences in propagation characteristics between the access and cross carrier frequencies. Call setup failures associated with pilot and traffic signal quality differences, in cross carrier channel assignments, may occur as a result of propagation characteristics differences in addition to, or in lieu of, rapidly fluctuating fading conditions.

Differences in propagation characteristics may result in an access carrier cell (or coverage area) that is different in size and/or shape from a cross carrier cell. When the cross carrier cell covers less geographical area than the access carrier cell, it becomes possible that a mobile station in the access carrier cell of one base station, i.e., serving base station, is also in the cross carrier cell of another base station (and not in the cross carrier cell of the serving base station). In such an event, call setup involving cross carrier channel assignment will fail at the serving base station.

Such call setup failure, in cross carrier channel assignments, may be resolved by having the mobile stations monitor the pilot channels in all carrier frequencies when initiating call setup. The base station selection and subsequent traffic channel assignment will then be based on the signal quality measurements of the pilot channels. However, such a solution is undesirable because it would necessitate a change in mobile station functionality.

Accordingly, there exists a need for improving call setup during cross carrier channel assignments in multi-carrier wireless communication systems without changing mobile station functionality.

### SUMMARY OF THE INVENTION

An embodiment of the present invention is a method of call setup in a wireless communication system in which traffic channels at a serving base station and one or more neighbor base stations are assigned to a mobile station during system access to improve call setup, particularly in cross carrier channel assignments when the mobile station is in a cross carrier cell of one of the neighbor base stations. One illustrative embodiment involves a multi-carrier wireless communication system in which a mobile station selects the serving base station based on the signal quality of an access carrier. Traffic channels are assigned to the mobile station on the cross carrier at the serving base station and one or more neighbor base stations. If the cross carrier cell of the serving base station covers less geographical area than a corresponding access carrier cell, then the mobile station may be in the cross carrier cell of a neighbor base station. In such a case, the mobile station should be able to establish a communication link with that neighbor base station even though it may not be able to establish a communication link with the serving base station, thereby allowing for the completion of call setup in cross carrier channel assignments.

### BRIEF DESCRIPTION OF THE DRAWINGS

The features, aspects, and advantages of the present invention will become better understood with regard to the following description, appended claims, and accompanying drawings where:

FIG. 1 depicts a multi-carrier wireless communication system used in accordance with the present invention;

FIG. 2 depicts a coverage diagram illustrating access carrier X and cross carrier Y cells in an ideal multi-carrier wireless communication system;

FIG. 3 depicts a coverage diagram illustrating access carrier X and cross carrier Y cells in an non-ideal multi-carrier wireless communication; and

FIG. 4 depicts a flowchart illustrating a call setup procedure in accordance with one embodiment of the present invention.

### DETAILED DESCRIPTION

An embodiment of the present invention is a method of call setup in a wireless communication system in which traffic channels at a serving base station and one or more neighbor base stations are assigned to a mobile station during system access to improve call setup, particularly in cross carrier channel assignments when the mobile station is in a cross carrier cell (or coverage area) of one of the neighbor base stations.

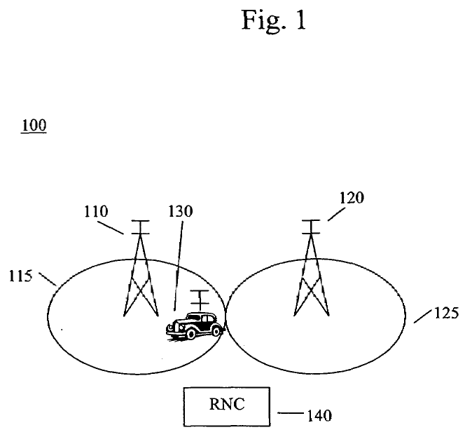

FIG. 1 depicts a multi-carrier wireless communication system 100 used in accordance with the present invention. In one embodiment, wireless communication system 100 incorporates well-known third generation wireless communication technology, such as Universal Mobile Telecommunication System (UMTS) or Code Division Multiple Access 2000 (CDMA2000) technology. Wireless communication system 100 comprises base stations 110 and 120, mobile station 130 and radio network controller (RNC) 140. Each base station 110 and 120 utilizes at least two pairs of carrier frequencies for communication with mobile station 130, wherein a pair of carrier frequencies include an uplink and a downlink carrier frequency. For purposes of illustration, wireless communication system 100 will be discussed herein with respect to two pairs of carrier frequencies referred to herein as “carriers X and Y.” In the downlink, a set of communication channels is associated with each of the carriers X and Y. Each set of communication channels include at least a pilot channel, a paging channel, and a plurality of traffic channels.

Carrier X is the carrier frequency used by mobile station 130 to access the wireless communication system and establish a communication link with the wireless communication system, as will be described later herein. Carrier X is also referred to herein as “access carrier X.” Carrier Y is any carrier frequency which is not access carrier X. Carrier Y is also referred to herein as “cross carrier Y.”

Traffic channels may be assigned to mobile station 130 on either access carrier X or cross carrier Y. If the assigned traffic channel is on access carrier X, the channel assignment is referred to herein as a “same carrier channel assignment.” If the assigned traffic channel is on cross carrier Y, the channel assignment is referred to herein as a “cross carrier channel assignment.”

Base stations 110 and 120 provide telecommunication services to mobile stations within their respective cell or geographical coverage areas 115 and 125, respectively. Each cell 115 and 125 comprises an access carrier X cell and a cross carrier Y cell in which telecommunication services are provided to mobile stations over carriers X and Y. Differences in propagation characteristics between carriers X and Y may affect the size and/or shape of the respective cells. In an ideal or optimized multi-carrier wireless communication system, the access carrier X and cross carrier Y cells in each cell 115 and 125 are configured to be approximately the same size and shape, thus completely (or almost completely) overlapping each other.

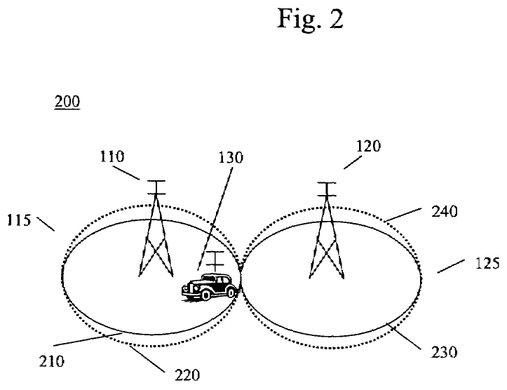

FIG. 2 depicts a coverage diagram 200 illustrating access carrier X and cross carrier Y cells in an ideal multi-carrier wireless communication system. Cell 115 comprises access carrier X and cross carrier Y cells 210 and 220, respectively. Cell 125 comprises access carrier X and cross carrier Y cells 230 and 240, respectively. Access carrier X and cross carrier Y cells 210 and 220 are identical, or nearly identical, in size and shape. Similarly, access carrier X and cross carrier Y cells 230 and 240 are identical, or nearly identical, in size and shape. A mobile station within access carrier X cell 210 should also be within its corresponding cross carrier Y cell 220. Likewise, a mobile station within access carrier X cell 230 should also be within its corresponding cross carrier Y cell 240. Signal quality for a pilot channel in access carrier X should be a reliable indicator of signal quality for a traffic channel in cross carrier Y. That is, the signal quality difference between the access carrier X pilot channel and the cross carrier Y traffic channel should be insignificant or non-existence.

Cross carrier channel assignments in ideal multi-carrier wireless communication systems should not result in call setup failure due to differences in propagation characteristics of access carrier X and cross carrier Y. However, configuring the access carrier X and cross carrier Y cells to be identical in size and shape would require extra resources, such as antennas and radios, thereby increasing cost. For illustrative purposes, the cross carrier Y cells 220 and 240 are shown as slightly larger and rounder than the access carrier X cells 210 and 230, respectively, even though such cells may be identical in size and/or shape.

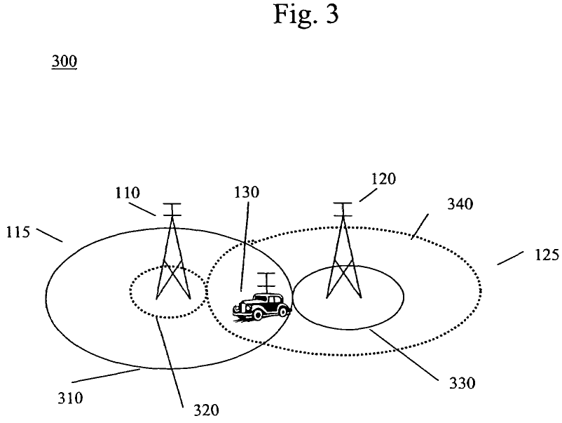

In a non-ideal or non-optimized multi-carrier wireless communication system, the access carrier X and cross carrier Y cells for each base station would not be the same size and/or shape, thus not completely overlapping each other. FIG. 3 depicts a coverage diagram 300 illustrating access carrier X and cross carrier Y cells in a non-ideal multi-carrier wireless communication system. Cell 115 comprises access carrier X and cross carrier Y cells 310 and 320, respectively. Cell 125 comprises access carrier X and cross carrier Y cells 330 and 340, respectively. Access carrier X cell 310 covers more geographical area than cross carrier Y cell 320 and, thus, they are not identical in size and/or shape. A mobile station, e.g., mobile station 130, within access carrier X cell 310 would not necessarily be within cross carrier Y cell 320. Similarly, cross carrier Y cell 340 covers less geographical area than access carrier X cell 330 and, thus, they are not identical in size and/or shape. A mobile station within cross carrier Y cell 340 would not necessarily be within access carrier X cell 330.

In the non-ideal multi-carrier wireless communication system, signal quality of a pilot channel in access carrier X would not be a reliable indicator of signal quality of a traffic channel in cross carrier Y. There may be an appreciable signal quality difference between the access carrier X pilot channel and the cross carrier Y traffic channel. In cross carrier channel assignments, call setup may fail when propagation characteristics differences result in the cross carrier Y cell covering less geographical area than the access carrier X cell.

An embodiment of the present invention addresses this cross carrier channel assignment problem by assigning cross carrier Y traffic channels at a serving base station and one or more neighbor base stations during system access. If the cross carrier Y cell of the serving base station covers less geographical area than the corresponding access carrier X cell, then the mobile station may be in the cross carrier Y cell of one of the neighbor base stations. In such a case, the mobile station should be able to establish a communication link with that neighbor base station even though it may not be able to establish a communication link with the serving base station, thereby improving call setup in cross carrier channel assignments.

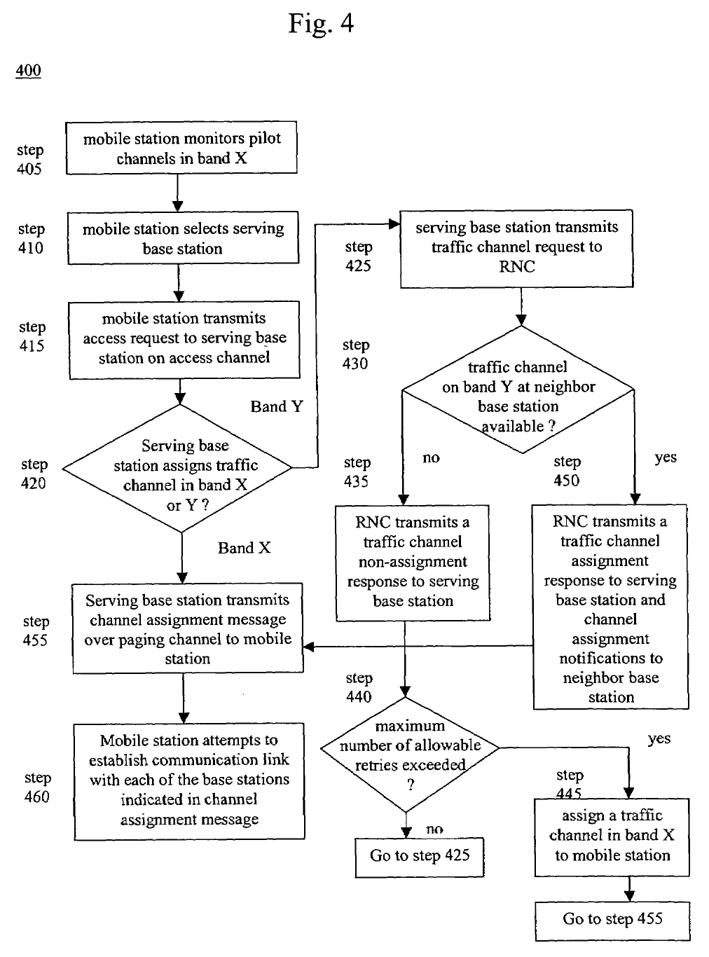

FIG. 4 depicts a flowchart 400 illustrating a call setup procedure in accordance with one embodiment of the present invention. In step 405, mobile station 130 measures the signal strengths of the access carrier X pilot channels. In step 410, mobile station 130 selects one of the base stations 110 and 120 as its serving base station based on the signal strength measurements of the pilot channels. Typically, the serving base station would be the base station with the strongest pilot signal strength measurement (or best signal quality). In another embodiment, the serving base station might be selected based on its distance to mobile station 130.

In step 415, mobile station 130 transmits an access request, also known as an “access probe,” to the serving base station over an access channel (or some other control channel) on one of the uplink carrier frequencies. The access request is a request to the serving base station for a traffic channel assignment. The access request may also indicate other base stations with strong pilot signal strength measurements on the access carrier X. In step 420, the serving base station and RNC allocate resources to mobile station 130 for setting up a traffic channel (i.e., assign a traffic channel) in response to the access request. The assigned traffic channel may either be on access carrier X or cross carrier Y.

If a cross carrier Y traffic channel is assigned, i.e., cross carrier channel assignment, then flowchart 400 continues to step 425. Otherwise, if an access carrier X traffic channel is assigned, i.e., same carrier channel assignment, then flowchart 400 continues to step 455. In step 425, the serving base station will send a traffic channel request to RNC 140. The traffic channel request is a request for the assignment of traffic channels in cross carrier Y from one or more selected base stations neighboring the serving base station, i.e., neighbor base stations. In another embodiment, the traffic channel request may be a request for the assignment of traffic channels on access carrier X, or both access carrier X and cross carrier Y, from one or more neighbor base stations.

The neighbor base stations may be selected based on a list of neighbor base stations, i.e., neighbor list. Each base station 110 and 120 maintains a neighbor list. The neighbor list, in one embodiment, is a list of neighbor base stations which can be used for cross carrier Y traffic channel assignment. The neighbor list may include priority levels or rankings associated with the neighbor base stations. The neighbor base stations can be selected based on the priority levels or rankings (e.g., base stations with highest priority levels are selected first). In another embodiment, the neighbor base stations are selected based on an access request that indicates one or more neighbor base stations with strong signal strength measurements. The selected base stations may include the neighbor base stations indicated in the access request and any base stations adjacent to both the serving base station and the indicated neighbor base stations. The number of selected base stations may be limited, for example, to five neighbor base stations. In yet another embodiment, the neighbor base stations may be selected based on the location of mobile station 130. For example, if the serving base station has knowledge that mobile station 130 is in a particular sector of its cell, then serving base station may select the neighbor base stations adjacent to that sector.

In step 430, in response to the traffic channel request, RNC 140 determines whether traffic channels in cross carrier Y can be assigned to mobile station 130 at the neighbor base stations indicated in the traffic channel request. RNC 140 maintains information regarding availability of resources, such as carrier width and radio units, at each base station 110 and 120. Based on such availability, RNC 140 determines whether cross carrier Y traffic channels at the selected neighbor base stations may be assigned to mobile station 130.

If a cross carrier Y traffic channel at a neighbor base station is not available for assignment, RNC 140 sends a traffic channel non-assignment response to mobile station 130, in step 435. The traffic channel non-assignment response indicates to the serving base station that no cross carrier Y traffic channels at any of the selected neighbor base stations are available to be assigned to mobile station 130. In step 440, upon receipt of the traffic channel non-assignment response, the serving base station checks a retry count corresponding to a number of traffic channel requests sent after the initial traffic channel request. The maximum number of retries can be zero or greater. If the retry count is less than a maximum number of allowable retries, then flowchart 400 returns to step 425 where the serving base station sends another traffic channel request to RNC 140. Such traffic channel request may be a request for cross carrier Y traffic channel assignment at the same or different neighbor base stations as indicated in a previous traffic channel request. If the retry count is greater than or equal to the maximum number of allowable retries, then flowchart 400 continues to step 445 where the serving base station changes the traffic channel assignment to an access carrier X traffic channel, i.e., same carrier channel assignment.

If a cross carrier Y traffic channel at one or more neighbor base station is available for assignment, then RNC 140 sends a traffic channel assignment response to the serving base station and one or more channel assignment notifications to the neighbor base stations associated with the assigned cross carrier Y traffic channels, in step 450. The traffic channel assignment response indicates to the serving base station the assigned cross carrier Y traffic channels at its neighbor base station. The channel assignment notification indicates to a neighbor base station its cross carrier Y traffic channel being assigned.

From steps 420, 445 and 450, flowchart 400 goes to step 455 where the serving base station transmits a channel assignment message to mobile station 130 indicating the assigned traffic channels at the serving base station and, if applicable, the assigned traffic channels at the neighbor base stations. The channel assignment message is transmitted over a paging channel on access carrier X. In step 460, mobile station 130 will attempt to establish communication links with each of the base stations using the assigned traffic channels indicated in the channel assignment message. If mobile station is not able to establish at least one communication link, call setup is deemed a failure. Otherwise, call setup is completed and deemed a success.

Upon completion of call setup, mobile station 130 will manage its communication link, for example, by monitoring the pilot channel in the same carrier as its traffic channels in order to initiate handoffs, if necessary. For cross carrier Y assignments, mobile station 130 will manage its communication link in cross carrier Y. For same carrier assignments, mobile station 130 will manage its communication link in access carrier X.

Note that call setup is completed and successful if the mobile station can establish a communication link with at least one base station. In cross carrier channel assignments, a mobile station may not be able to successfully establish a communication link with the serving base station because the cross carrier Y cell may cover less geographical area than the access carrier X cell of the serving base station. In such a situation, the mobile station may be within the cross carrier Y cell of a neighbor base station instead of the cross carrier Y cell of its serving base station. By assigning a cross carrier Y traffic channel to the mobile station at one or more neighbor base stations (in addition to the serving base station), there is an increased likelihood that the mobile station will be able to establish at least one communication link, whether such communication link is with the serving base station or one of the neighbor base stations. For example, suppose mobile station 130 in FIG. 3 is assigned a cross carrier Y traffic channel at both base station 110 and 120. Although mobile station 130 is outside cross carrier Y cell 320 of serving base station 110, it is within cross carrier Y cell 340 of neighbor base station 120. Thus, mobile station 130 should be able to complete call setup by establishing a communication link in cross carrier Y with neighbor base station 120.

Further note that if a mobile station is able to establish a communication link with two or more base stations during call setup, the mobile station will enter into soft handoff mode. Soft handoff is a technique for maintaining or managing a communication link while the mobile station traverses from the cell of one base station to another. Soft handoff is well-known in the art.

Although the present invention has been described in considerable detail with reference to certain embodiments, other versions are possible. For example, traffic channels at a plurality of base stations may be assigned to a mobile station in same carrier channel assignments or in single carrier wireless communication systems. Therefore, the spirit and scope of the present invention should not be limited to the description of the embodiments contained herein.

1. A method of call setup in a wireless communication system comprising the steps of:
assigning a first traffic channel, to a mobile station, at a first base station;
assigning a second traffic channel, to the mobile station, at a second base station; and
transmitting a channel assignment message, to the mobile station, over a paging channel indicating the first and second traffic channels.

2. The method of claim 1 comprising the additional step of:
transmitting a pilot signal over a pilot channel from the first base station, wherein the first traffic channel is on a first carrier at a first frequency, the pilot and paging channels are on a second carrier at a second frequency, and the first and second frequencies are different.

3. The method of claim 2, wherein the second carrier frequency is an access carrier used for system access.

4. The method of claim 3 further comprising the step of:
prior to the step of assigning the first traffic channel, receiving an access request from the mobile station over an access channel requesting assignment of a traffic channel at the first base station, wherein the access request is based on signal strength measurements of the pilot channels at the mobile station.

5. The method of claim 1, wherein the step of assigning the second traffic channel comprises the step of:
selecting the second base station based on a position of the mobile station.

6. The method of claim 1, wherein the first base station is a serving base station and the second base station is a neighbor base station.

7. A method of call setup in a wireless communication system comprising the steps of:
receiving a channel assignment message over a paging channel, wherein the channel assignment message indicates a first traffic channel at a first base station and a second traffic channel at a second base station; and
establishing a communication link with at least one of the first or second base stations using the first or second traffic channels indicated in the channel assignment message.

8. The method of claim 7 further comprising the step of:
prior to the step of receiving the channel assignment message, monitoring pilot channels on a first carrier at a first frequency associated with the first and second base stations, wherein at least one of the first and second traffic channels are on a second carrier at a second frequency, and the first and second frequencies are different.

9. The method of claim 8 further comprising the step of:
transmitting an access request over an access channel requesting assignment of a traffic channel at the first base station based on the monitored pilot channels.

10. The method of claim 7, wherein the first base station is a serving base station and the second base station is a base station neighboring the serving base station.

11. The method of claim 7 comprising the additional step of:
operating in soft handoff mode if communication links can be established with both the first base station and second base station.

12. A method of call setup in a multi-carrier wireless communication system having a set of communication channels on each of a first carrier at a first frequency and second carrier at a second frequency, the method comprising the steps of:
determining whether a first traffic channel on the first carrier frequency is available for assignment at a first base station;
if the first traffic channel is available for assignment, transmitting a first channel assignment message indicating assignment of the first traffic channel and a second traffic channel on the first carrier at a second base station; and
if the first traffic channel is not available for assignment, transmitting a channel assignment message indicating assignment of a third traffic channel on the second carrier frequency at the second base station.

13. The method of claim 12, wherein the step of determining whether the first traffic channel is available comprises the step of:
determining, up to a maximum number of allowable retries, whether resources are available at a neighbor base station for assigning a traffic channel in the first carrier frequency.

14. The method of claim 12, wherein the second base station is a serving base station and the first base station is a neighboring base station.
